(19) United States
(12) Patent Application Publication
(10) Pub. No.: US 2026/0179870 A1
(43) Pub. Date: Jun. 25, 2026

(54) FUSE BOX FOR HIGH-VOLTAGE BATTERY

(71) Applicant: HYUNDAI MOBIS CO., LTD., Seoul (KR)

(72) Inventors: Jae Seung LEE, Yongin-si (KR); Hyung Bin CHO, Yongin-si (KR); Sang Gil KIM, Yongin-si (KR)

(73) Assignee: HYUNDAI MOBIS CO., LTD., Seoul (KR)

(21) Appl. No.: 19/426,281

(22) Filed: Dec. 19, 2025

(30) Foreign Application Priority Data
Dec. 19, 2024 (KR) 10-2024-0191543

(51) Int. Cl. H01H 85/25; H01H 9/22; H01H 85/00; H01H 85/02; H01H 85/042

(52) U.S. Cl. CPC H01H 85/25; H01H 9/226; H01H 85/0095; H01H 85/0241; H01H 85/042

(57) ABSTRACT

A fuse box for a high-voltage battery is provided. The fuse box includes a fuse module and a short-circuit part. The fuse module includes a high-voltage fuse installed in a path of a supply line provided at one side of a vehicle, the high-voltage fuse connected to the high-voltage battery to receive power from the high-voltage battery, and an accommodation part having an internal space in which the high-voltage fuse is accommodated, the accommodation part for electrically connecting the high-voltage fuse to the supply line. The short-circuit part is installed at one side of the fuse module to short-circuit the supply line in response to the internal space of the accommodation part being opened.

### CROSS-REFERENCE TO RELATED APPLICATION

This application claims priority to and the benefit under 35 USC § 119(a) of Korean Patent Application No. 10-2024-0191543 filed in the Korean Intellectual Property Office on Dec. 19, 2024, the entire contents of which are incorporated herein by reference for all purposes.

### BACKGROUND

### 1. Field

The present disclosure relates to a fuse box for a high-voltage battery, and more particularly, to a fuse box for a high-voltage battery, in which a microswitch of a short-circuit part operates to quickly short-circuit an interlock circuit when a cover member of the fuse box is removed or detached during a process of replacing a high-voltage fuse, such that an operation of a system is cut off, thereby protecting an operator, who replaces the high-voltage fuse, from a risk of electric shock and ensuring safety of the operator.

### 2. Description of the Related Art

In general, an interlock circuit refers to a system safety function device configured to monitor the connectivity of an internal circuit and cut off an operation of a system. In the case of a high-voltage battery system for a vehicle, the interlock circuit is related to a technology that monitors the connectivity of a high-voltage circuit and operates a relay to cut off the system in order to protect the system and ensure the safety of an operator.

In the related art, a separate interlock circuit is not provided in a fuse box for a high-voltage battery in the high-voltage battery system, and only an interlock circuit is connected to fasten an internal connector of the system and protects the system and the operator by controlling an interlock signal depending on whether the connector is mounted.

For this reason, because the interlock circuit is not provided in the fuse box in the high-voltage battery system in the related art, there is a problem in that the safety of the operator cannot be ensured when the operator performs the process of replacing the high-voltage fuse without recognizing a situation in which a high-voltage connector is connected or an internal interlock circuit is short-circuited during the process of replacing the fuse.

Further, in case that the interlock circuit is configured in the fuse box by using the connector in the related art, there is a problem in that the volume and weight of a fuse box injection-molded product are increased, and an additional external force is required to detach the connector, which degrades workability in repairing and replacing the fuse box.

### SUMMARY

The present disclosure has been made in an effort to provide a fuse box for a high-voltage battery, in which a microswitch of a short-circuit part operates to quickly short-circuit an interlock circuit when a cover member of the fuse box is removed or detached during a process of replacing a high-voltage fuse, such that an operation of a system is cut off, thereby protecting an operator, who replaces the high-voltage fuse, from a risk of electric shock and ensuring safety of the operator.

In a general aspect of the disclosure, a fuse box for a high-voltage battery includes: a fuse module including a high-voltage fuse installed in a path of a supply line provided at one side of a vehicle, the high-voltage fuse connected to a high-voltage battery, and configured to be supplied with power from the high-voltage battery, and an accommodation part having an internal space in which the high-voltage fuse is accommodated, the accommodation part being configured to electrically connect the high-voltage fuse to the supply line; and a short-circuit part installed at one side of the fuse module and configured to short-circuit the supply line in response to the internal space of the accommodation part being opened.

The accommodation part may include: a housing having an internal space, in which the high-voltage fuse is accommodated, the housing having an opening side configured to be opened at one side thereof; and a cover member detachably installed on the opening side, and the short-circuit part may be installed to selectively come into contact with one side of the cover member in order to control whether the supply line is short-circuited in conjunction with whether the cover member is attached or detached.

The short-circuit part may include a microswitch including: a body installed in the housing and connected to the supply line; and a switch member having one end installed on an upper surface of the body and configured to be movable upward or downward in a height direction of the body so that the switch member selectively comes into contact with the cover member.

The switch member may be made of a material having elasticity and elastically supported upward in the height direction of the body.

The fuse box may further include a separate elastic body installed between the body and the switch member so that the switch member is elastically supported upward in the height direction of the body.

The fuse box may further include a curved piece provided in an upper surface region of an end of the switch member that selectively comes into contact with the cover member.

The fuse box may further include a high-voltage connector installed on the accommodation part, wherein one side of the short-circuit part and the high-voltage battery may be electrically connected through the high-voltage connector.

The other side of the short-circuit part may be connected to a battery management system, and a separate communication connector may be installed between the battery management system and the high-voltage connector.

In another general aspect of the disclosure, a fuse box system for a high-voltage battery of a vehicle, includes: a fuse module including a high-voltage fuse installed in a path of a supply line provided at one side of a vehicle, the high-voltage fuse connected to the high-voltage battery and configured to receive power from the high-voltage battery, and an accommodation part having an internal space in which the high-voltage fuse is accommodated, the accommodation part being configured to electrically connect the high-voltage fuse to the supply line; and a short-circuit part installed at one side of the fuse module and including a housing having an internal space, in which the high-voltage fuse is accommodated, the housing having an opening side configured to be opened at one side thereof, and a cover member detachably installed on the opening side, wherein, in response to the cover member being detached from the opening side, the short-circuit part is configured to short-circuit the supply line.

The short-circuit part may be installed to selectively come into contact with one side of the cover member to short-circuit the supply line.

The short-circuit part may include a microswitch including a body installed in the housing and connected to the supply line, and a switch member having one end installed on an upper surface of the body and configured to be movable upward or downward in a height direction of the body so that the switch member selectively comes into contact with the cover member.

Further, when the battery management system transmits an interlock signal in case that the short-circuit part is connected, the battery management system may receive the interlock signal through the communication connector, such that the battery management system may operate normally.

According to the fuse box for a high-voltage battery according to the present disclosure described above, the microswitch of the short-circuit part may operate to quickly short-circuit the interlock circuit when the cover member of the fuse box is removed or detached during the process of replacing the high-voltage fuse, such that the operation of the system may be cut off, thereby protecting the operator, who replaces the high-voltage fuse, from a risk of electric shock and ensuring the safety of the operator.

Further, the fuse box for a high-voltage battery according to the present disclosure may additionally protect the system by compensating for a defect occurring in the interlock circuit installed in the high-voltage connector of the system, or by coping with the state in which the interlock circuit is fixed.

### BRIEF DESCRIPTION OF THE DRAWINGS

FIG. 1 is a perspective view illustrating a structure in which a cover member of a fuse box for a high-voltage battery according to the present disclosure is separated.

FIG. 2 is a perspective view illustrating a structure of a short-circuit part according to another embodiment of the fuse box for a high-voltage battery according to the present disclosure.

FIG. 3 is a schematic view schematically illustrating an electrical connection structure of the fuse box for a high-voltage battery according to the present disclosure.

FIG. 4 is a flowchart sequentially illustrating an operational process of an interlock circuit of the fuse box for a high-voltage battery according to the present disclosure.

### DETAILED DESCRIPTION

Hereinafter, a fuse box for a high-voltage battery according to an embodiment of the present disclosure will be described in more detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

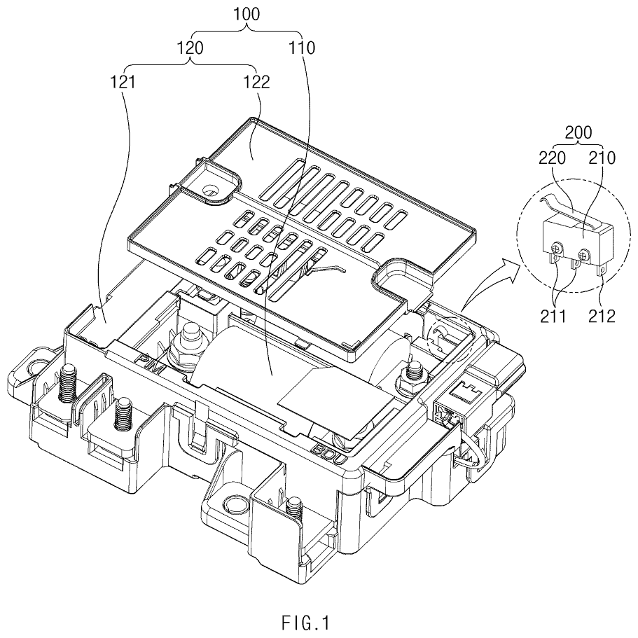

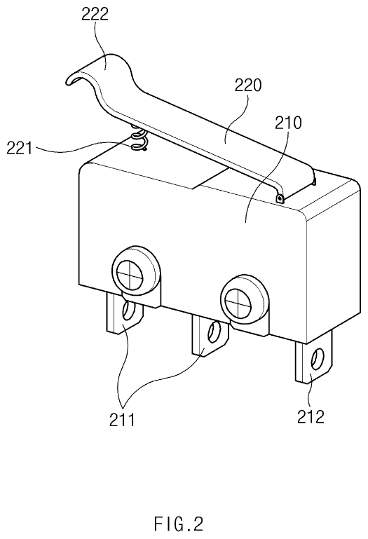

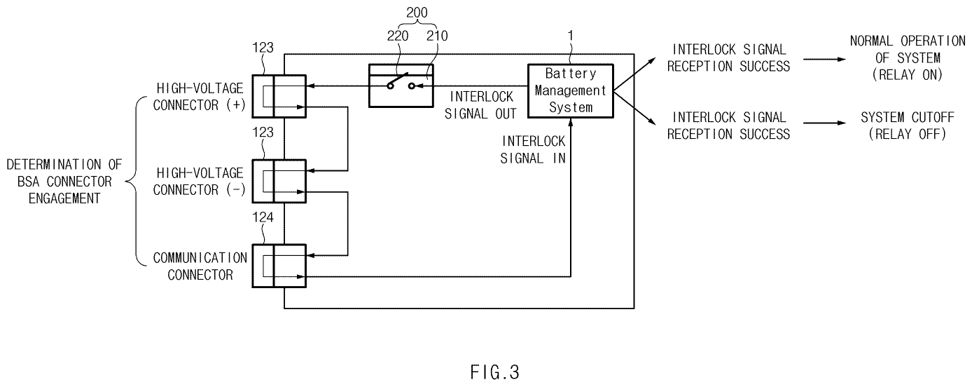

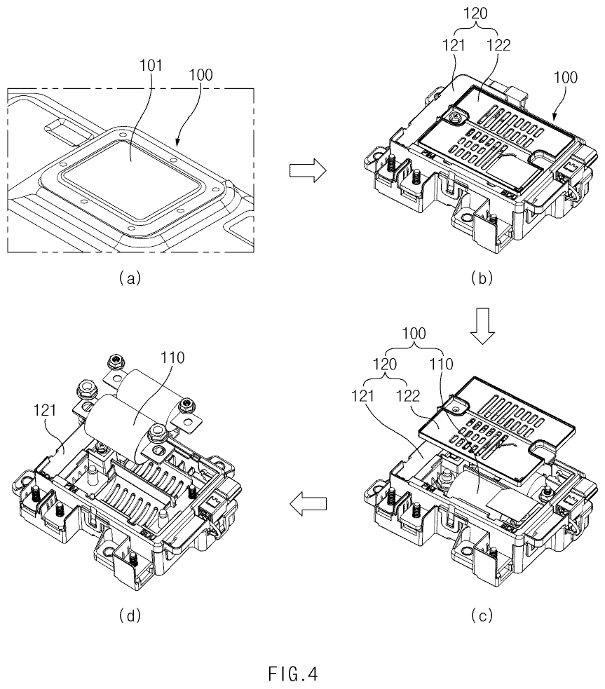

FIG. 1 is a perspective view illustrating a structure in which a cover member of a fuse box for a high-voltage battery according to the present disclosure is separated, FIG. 2 is a perspective view illustrating a structure of a short-circuit part according to another embodiment of the fuse box for a high-voltage battery according to the present disclosure, FIG. 3 is a schematic view schematically illustrating an electrical connection structure of the fuse box for a high-voltage battery according to the present disclosure, and FIG. 4 is a flowchart sequentially illustrating an operational process of an interlock circuit of the fuse box for a high-voltage battery according to the present disclosure.

As illustrated in these drawings, the fuse box for a high-voltage battery according to the present disclosure includes a fuse module 100 including a high-voltage fuse 110 installed in a path of a supply line provided at one side of a vehicle, connected to a high-voltage battery, and configured to be supplied with power from the high-voltage battery, and an accommodation part 120 having an internal space in which the high-voltage fuse 110 is accommodated, the accommodation part 120 being configured to electrically connect the high-voltage fuse 110 to the supply line; and a short-circuit part 200 installed at one side of the fuse module 100 and configured to short-circuit the supply line when the internal space of the accommodation part 120 is opened.

The fuse module 100 may include the high-voltage fuse 110 configured to prevent an accident by being short-circuited in case that an excessive electric current flows, and the accommodation part 120 configured to define an external appearance and having the internal space that may accommodate the high-voltage fuse 110.

The high-voltage fuse 110 is installed in the path of the supply line connected to the high-voltage battery and serves to short-circuit the supply line in case that an excessive amount of electric current is supplied from the high-voltage battery, thereby preventing damage to components caused by an overcurrent.

As illustrated in FIG. 1, the high-voltage fuse 110 may be provided as a plurality of high-voltage fuses 110 accommodated in the accommodation part 120 and electrically connected. Two opposite ends of the high-voltage fuse 110 may be inserted into bolt-shaped terminals provided on the accommodation part 120. A nut may be fastened to the terminal so that the high-voltage fuse 110 is securely installed without inadvertently moving.

The accommodation part 120 is a member that defines an external shape of the fuse module 100, and an accommodation space capable of accommodating the high-voltage fuse 110 is formed in the internal space of the accommodation part 120.

The accommodation part 120 may include a housing 121 having an internal space, in which the high-voltage fuse 110 is accommodated, the housing 121 having an opening side opened at one side thereof, and a cover member 122 detachably installed on the opening side.

The housing 121 may have the opening side opened at one side thereof, and the cover member 122 may be detachably installed on the opening side. A fuse maintenance window 101 may be disposed outside the cover member 122 and fastened and assembled to the housing 121 by separate bolts.

The short-circuit part 200 is installed at one side of the fuse module 100 and configured to short-circuit the supply line when the internal space of the accommodation part 120 is opened, thereby preventing a situation in which an operator is exposed to a risk of electric shock because a battery management system 1 consistently supplies power without detecting a process of replacing the high-voltage fuse 110 during the process of replacing the high-voltage fuse 110.

To this end, the short-circuit part 200 may be installed to selectively come into contact with one side of the cover member 122 in order to control whether the supply line is short-circuited in conjunction with whether the cover member 122 is attached or detached.

That is, the present disclosure provides the fuse box for a high-voltage battery according to the present disclosure in which a high voltage supplied from the high-voltage battery is short-circuited by the short-circuit part 200 only by an operation of detaching the cover member 122 to replace a fuse installed in the fuse box, thereby basically ensuring the safety of the operator.

The short-circuit part 200 may include a microswitch. The microswitch refers to a small-scale switch in which a contact mechanism, which includes a minute contact gap and a snap operation mechanism and is opened or closed by a specified motion and a specified force, is installed in a casing, and an actuator is provided outside the casing.

As illustrated in FIG. 3, one side of the short-circuit part 200 may be electrically connected to the high-voltage battery by high-voltage connectors 123 installed on the accommodation part 120.

Further, it is effective that the other side of the short-circuit part 200 is connected to the battery management system 1, and a separate communication connector 124 is installed between the battery management system 1 and the high-voltage connector 123.

The short-circuit part 200 will be described more specifically. As illustrated in FIGS. 1 and 2, the short-circuit part 200 may include a body 210 installed in the housing 121 and connected to the supply line, and a switch member 220 having one end installed on an upper surface of the body 210 and configured to be movable in a height direction of the body 210 so that the switch member 220 selectively comes into contact with the cover member 122.

The body 210 is a member that defines an external appearance of the short-circuit part 200. The body 210 may be formed in various shapes. The body 210 of the short-circuit part 200, which constitutes the fuse box for a high-voltage battery according to the present disclosure, is formed in a rectangular shape.

Further, separate high-voltage terminals 211 and a separate communication terminal 212 protrude from one side of the body 210 and are respectively electrically connected to the high-voltage connectors 123 and the communication connector 124 provided in the housing 121.

One end of the switch member 220 is installed on the upper surface of the body 210 and configured to be movable in the height direction of the body 210. The switch member 220 is disposed to be inclined upward from one end toward the other end thereof so as to selectively come into contact with the cover member 122. The other end of the switch member 220 comes into contact with a lower surface of the cover member 122 and is pressed downward, such that the short-circuit part 200 is electrically conducted.

As illustrated in FIG. 1, the switch member 220 may be made of a material having elasticity, such that the switch member 220 is elastically supported upward in the height direction of the body 210. Therefore, when the cover member 122 is detached from the housing 121, the switch member 220 is restored to the original inclined position, such that the supply of power to the short-circuit part 200 is cut off.

Further, as illustrated in FIG. 2, the switch member 220 may include a separate elastic body 221 installed between the body 210 and the switch member 220 so that the switch member 220 may be elastically supported upward in the height direction of the body 210.

In case that the separate elastic body 221, such as a compression coil spring, is installed between the body 210 and the switch member 220, a restoring force of the separately installed elastic body 221 may allow the switch member 220 to normally ascend or descend consistently even though the elastic restoring force of the switch member 220 decreases because the cover member 122 is continuously and repeatedly attached and detached.

In addition, a curved piece 222, which is formed to be curved, is provided in an upper surface region of an end of the switch member 220 that selectively comes into contact with the cover member 122, such that friction of a contact portion may be reduced even though the switch member 220 continuously and repeatedly comes into contact with or separates from the cover member 122. Therefore, it is possible to prevent damage to surfaces of the switch member 220 and the cover member 122.

With the above-mentioned configuration, when the battery management system 1 transmits an interlock signal in case that the short-circuit part 200 is connected, the battery management system 1 receives the interlock signal through the communication connector 124, such that the battery management system 1 operates normally.

Further, on the contrary, even though the battery management system 1 transmits the interlock signal in a state in which the short-circuit part 200 is short-circuited, the battery management system 1 does not receive the interlock signal, and the battery management system 1 does not operate, thereby preventing an electric shock accident.

An operational process of the interlock circuit of the fuse box for a high-voltage battery according to the present disclosure, which is configured as described above, will be described below with reference to FIG. 3.

First, as illustrated in FIG. 4, part (a), in order to replace the high-voltage fuse 110 installed in the fuse box for a high-voltage battery according to the present disclosure, the plurality of bolts are loosened, and the fuse maintenance window 101 installed outside the fuse box is removed.

As illustrated in FIG. 4, part (b), when the fuse maintenance window 101 is removed, the cover member 122 is exposed to the outside. Fastening bolts are removed, and the cover member 122 exposed to the outside is separated from the housing 121.

As illustrated in FIG. 4, part (c), at the moment when the cover member 122 is separated from the housing 121, the switch member 220, which is provided on the body 210, which constitutes the short-circuit part 200, and pressed by being brought into contact with the cover member 122, is restored to the original position, and the short-circuit part 200 is short-circuited.

Because the battery management system 1 cannot receive the interlock signal transmitted from the battery management system 1 when the short-circuit part 200 is short-circuited, the entire system is cut off, and the supply of the high voltage from the high-voltage battery is immediately stopped.

In this state, as illustrated in FIG. 4, part (d), the operator may remove the damaged high-voltage fuse 110 from the housing 121 by using a separate tool and then install a new normal high-voltage fuse 110 in the housing 121, such that the process of replacing the high-voltage fuse 110 may be safely completed.

According to the fuse box for a high-voltage battery according to the present disclosure configured as described above, the microswitch of the short-circuit part may operate to quickly short-circuit the interlock circuit when the cover member of the fuse box is removed or detached during the process of replacing the high-voltage fuse, such that the operation of the system may be cut off, thereby protecting the operator, who replaces the high-voltage fuse, from a risk of electric shock and ensuring the safety of the operator.

While the embodiments, which may be implemented by the present disclosure, have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A fuse box for a high-voltage battery, the fuse box comprising:
a fuse module comprising:
a high-voltage fuse installed in a path of a supply line provided at one side of a vehicle, the high-voltage fuse connected to the high-voltage battery and configured to be supplied with power from the high-voltage battery; and
an accommodation part having an internal space in which the high-voltage fuse is accommodated, the accommodation part being configured to electrically connect the high-voltage fuse to the supply line; and
a short-circuit part installed at one side of the fuse module and configured to short-circuit the supply line in response to the internal space of the accommodation part being opened.

2. The fuse box of claim 1, wherein the accommodation part comprises:
a housing having an internal space in which the high-voltage fuse is accommodated, the housing having an opening side configured to be opened at one side thereof; and
a cover member detachably installed on the opening side, and
wherein the short-circuit part is installed to selectively come into contact with one side of the cover member in order to control whether the supply line is short-circuited in conjunction with whether the cover member is attached or detached.

3. The fuse box of claim 2, wherein the short-circuit part comprises a microswitch comprising:
a body installed in the housing and connected to the supply line; and
a switch member having one end installed on an upper surface of the body and configured to be movable upward or downward in a height direction of the body so that the switch member selectively comes into contact with the cover member.

4. The fuse box of claim 3, wherein the switch member is made of a material having elasticity and elastically supported upward in the height direction of the body.

5. The fuse box of claim 3, further comprising:
a separate elastic body installed between the body and the switch member so that the switch member is elastically supported upward in the height direction of the body.

6. The fuse box of claim 4, further comprising:
a curved piece provided in an upper surface region of an end of the switch member that selectively comes into contact with the cover member.

7. The fuse box of claim 5, further comprising:
a curved piece provided in an upper surface region of an end of the switch member that selectively comes into contact with the cover member.

8. The fuse box of claim 1, further comprising:
a high-voltage connector installed on the accommodation part,
wherein one side of the short-circuit part and the high-voltage battery are electrically connected through the high-voltage connector.

9. The fuse box of claim 7, wherein the other side of the short-circuit part is connected to a battery management system, and
wherein the fuse box further comprises a separate communication connector installed between the battery management system and the high-voltage connector.

10. A fuse box system for a high-voltage battery of a vehicle, the system comprising:
a fuse module comprising:
a high-voltage fuse installed in a path of a supply line provided at one side of a vehicle, the high-voltage fuse connected to the high-voltage battery and configured to receive power from the high-voltage battery; and
an accommodation part having an internal space in which the high-voltage fuse is accommodated, the accommodation part being configured to electrically connect the high-voltage fuse to the supply line; and
a short-circuit part installed at one side of the fuse module and comprising:
a housing having an internal space, in which the high-voltage fuse is accommodated, the housing having an opening side configured to be opened at one side thereof; and
a cover member detachably installed on the opening side,
wherein, in response to the cover member being detached from the opening side, the short-circuit part is configured to short-circuit the supply line.

11. The system of claim 10, wherein the short-circuit part is installed to selectively come into contact with one side of the cover member to short-circuit the supply line.

12. The system of claim 11, wherein the short-circuit part comprises a microswitch, the microswitch comprising:
a body installed in the housing and connected to the supply line; and
a switch member having one end installed on an upper surface of the body and configured to be movable upward or downward in a height direction of the body so that the switch member selectively comes into contact with the cover member.
